(19) United States
(12) Patent Application Publication
(10) Pub. No.: US 2017/0133919 A1
(43) Pub. Date: May 11, 2017

(54) DUAL-PHASE DC-DC CONVERTER WITH PHASE LOCK-UP AND THE METHOD THEREOF

(71) Applicant: Chengdu Monolithic Power Systems Co., Ltd., Chengdu (CN)

(72) Inventor: Yike Li, Chengdu (CN)

(21) Appl. No.: 15/343,097

(22) Filed: Nov. 3, 2016

(30) Foreign Application Priority Data
Nov. 5, 2015 (CN) 201510744640.8

(51) Int. Cl. H02M 1/084; H02M 3/157

(52) U.S. Cl. CPC H02M 1/084; H02M 3/157

(57) ABSTRACT

The present invention discloses a dual-phase DC-DC converter with phase lock. The dual-phase DC-DC converter effectively controls the phase difference between the two power switching circuits by generating a square wave signal in response to logical control signals which are used to control the power switching circuits, so as to bring the phase difference between the two power switching circuits back to 180 degrees if there is derivation.

### CROSS-REFERENCE TO RELATED APPLICATIONS

This application claims priority to and the benefit of Chinese Patent Application No. 201510744640.8, filed Nov. 5, 2015, which is incorporated herein by reference in its entirety.

### FIELD

The present invention relates to electronic circuits, more specifically, the present invention relates to dual-phase DC-DC converter with phase lock-up and the method thereof.

### BACKGROUND

Constant on time (COT) control scheme is widely used in DC-DC converters due to quick transient response. However, compared to peak current mode control, the switching frequency of power conversion systems with COT control may not be well controlled.

In dual-phase or multi-phase DC-DC converters, because the switching frequency cannot be well controlled, the phase difference between different power stages cannot be well controlled, either, which is unacceptable.

### SUMMARY

A dual-phase DC-DC converter with phase lock is discussed. The dual-phase DC-DC converter generates a square wave signal based on logical control signals which are used to control two power switching circuits, to control the phase difference between the two power switching circuits to be back to 180 degrees if there is derivation.

### BRIEF DESCRIPTION OF THE DRAWINGS

FIG. 1 schematically shows a dual-phase DC-DC converter 100 in accordance with an embodiment of the present invention.

FIG. 2 schematically shows a dual-phase DC-DC converter 200 in accordance with an embodiment of the present invention.

FIG. 3 schematically shows a dual-phase DC-DC converter 300 in accordance with an embodiment of the present invention.

FIG. 4 schematically shows circuit configurations of the first on time generator 104 and the second on time generator 204 in accordance with an embodiment of the present invention.

FIG. 5 schematically shows a circuit configuration of the controlled voltage signal generator 46 in accordance with an embodiment of the present invention.

FIG. 6 schematically shows a circuit configuration of the controlled voltage signal generator 46 in accordance with an embodiment of the present invention.

FIG. 7 schematically shows a circuit configuration of the controlled current source 42 in accordance with an embodiment of the present invention.

FIG. 8 schematically shows a flow chart 400 of a method used in a dual-phase DC-DC converter.

The use of the similar reference label in different drawings indicates the same of like components.

### DETAILED DESCRIPTION

Embodiments of circuits for dual-phase DC-DC converter are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

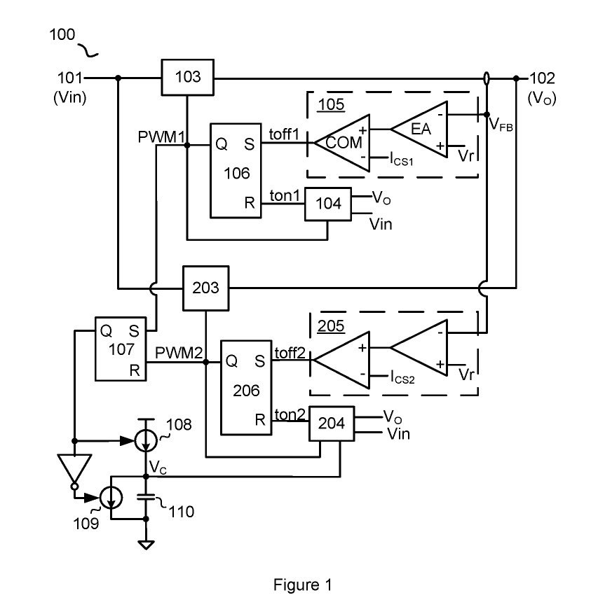

FIG. 1 schematically shows a dual-phase DC-DC converter 100 in accordance with an embodiment of the present invention. In the example of FIG. 1, the dual-phase DC-DC converter 100 comprises: an input port 101, configured to receive an input voltage Vin; an output port 102, configured to provide an output voltage V_{O}; a first power switching circuit 103, coupled between the input port 101 and the output port 102; a first on time generator 104, configured to receive the input voltage Vin, the output voltage V_{O} and a first logical control signal PWM1, to generate a first on time signal ton1; a first off time generator 105, configured to receive a reference voltage Vr, a first current sense signal I_{CS1} indicative of a current flowing through the first power switching circuit 103, and a feedback signal V_{FB} indicative of the output voltage V_{O}, to generate a first off time signal toff1; a first RS flip-flop 106, having a reset input terminal R, a set input terminal S and an output terminal Q, wherein the reset input terminal R is coupled to the first on time generator 104 to receive the first on time signal ton1, the set input terminal S is coupled to the first off time generator 105 to receive the first off time signal toff1, wherein the first RS flip-flop 106 generates the first logical control signal PWM1 at the output terminal Q based on the first on time signal ton1 and the first off time signal toff1, to control the operation of the first power switching circuit 103; a second power switching circuit 203, coupled in parallel with the first power switching circuit 103 between the input port 101 and the output port 102; a second on time generator 204, configured to receive the input voltage Vin, the output voltage V_{O}, a second logical control signal PWM2, and a compensation voltage V_{C}, to generate a second on time signal ton2; a second off time generator 205, configured to receive the reference voltage Vr, the feedback signal V_{FB}, and a second current sense signal I_{CS2} indicative of a current flowing through the second power switching circuit 203, to generate a second off time signal toff2; a second RS flip-flop 206, having a reset input terminal R, a set input terminal S and an output terminal Q, wherein the reset input terminal R is coupled to the second on time generator 204 to receive the second on time signal ton2, the set input terminal S is coupled to the second off time generator 205 to receive the second off time signal toff2, and wherein the second RS flip-flop 206 generates the second logical control signal PWM2 at the output terminal Q based on the second on time signal ton2 and the second off time signal toff2, to control the operation of the second power switching circuit 203; a RS latch 107, having a reset input terminal R, a set input terminal S and an output terminal Q, wherein the set input terminal S is coupled to the first RS flip-flop 106 to receive the first logical control signal PWM1, the reset input terminal R is coupled to the second RS flip-flop 206 to receive the second logical control signal PWM2, and wherein the RS latch 107 generates a square wave signal at the output terminal Q based on the first logical control signal PWM1 and the second logical control signal PWM2; a current source 108, configured to charge a first capacitor 110 when the square wave signal is at a first state (e.g. at logical high state); a current sink 109, configured to discharge the first capacitor 110 when the square wave signal is at a second state (e.g. at logical low state); and the first capacitor 110, wherein a voltage across the first capacitor 110 is the compensation voltage V_{C}, which is delivered to the second on time generator 204.

In one embodiment, the current source 108 and the current sink 109 provide a current with a same current level.

In the example of FIG. 1, the first off time generator 105 comprises: an error amplifier EA, having a first input terminal, a second input terminal and an output terminal, wherein the first input terminal is configured to receive the feedback signal V_{FB}, the second input terminal is configured to receive the reference voltage Vr, and wherein the error amplifier EA generates an error amplified signal at the output terminal by amplifying and integrating the difference between the feedback signal V_{FB} and the reference voltage Vr; a voltage comparator COM, having a first input terminal, a second input terminal, and an output terminal, wherein the first input terminal is coupled to the error amplifier EA to receive the error amplified signal, the second input terminal is configured to receive the first current sense signal I_{CS1} and wherein the voltage comparator COM generates the first off time signal toff1 by comparing the error amplified signal with the first current sense signal I_{CS1}.

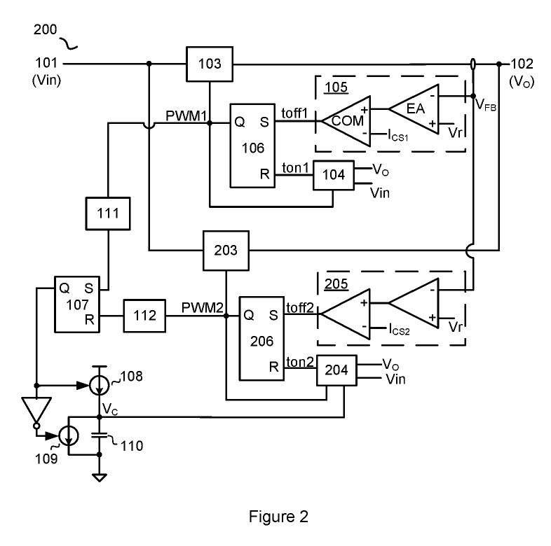

FIG. 2 schematically shows a dual-phase DC-DC converter 200 in accordance with an embodiment of the present invention. The dual-phase DC-DC converter 200 in FIG. 2 is similar to the dual-phase DC-DC converter 100 in FIG. 1. Different from the dual-phase DC-DC converter 100 in FIG. 1, the dual-phase DC-DC converter 200 in FIG. 2 further comprises: a first short pulse circuit 111, configured to receive the first logical control signal PWM1, to generate a first short pulse signal in response to a rising edge of the first logical control signal PWM1 to the set input terminal S of the RS latch 107; and a second short pulse circuit 112, configured to receive the second logical control signal PWM2, to generate a second short pulse signal in response to a rising edge of the second logical control signal PWM2 to the reset input terminal R of the RS latch 107.

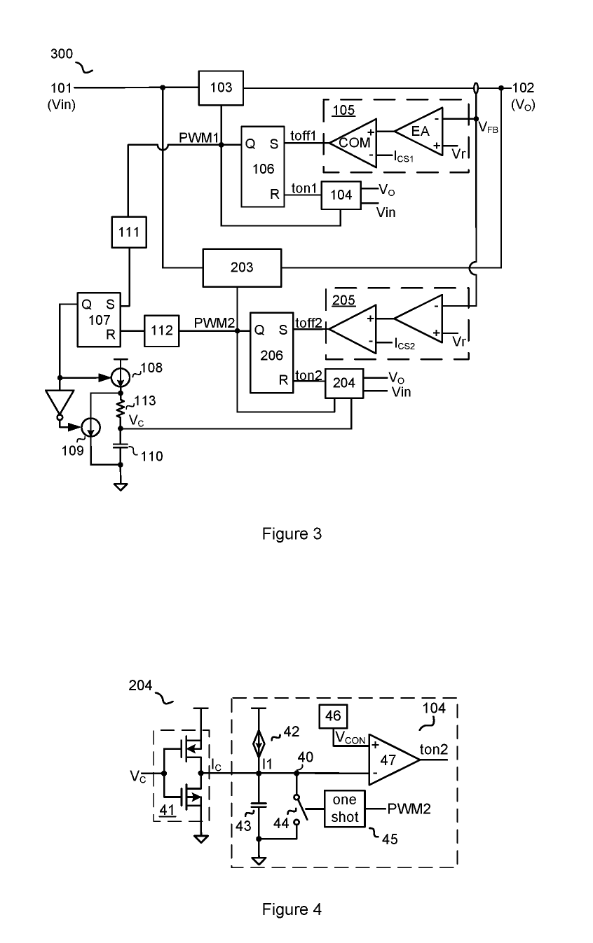

FIG. 3 schematically shows a dual-phase DC-DC converter 300 in accordance with an embodiment of the present invention. The dual-phase DC-DC converter 300 in FIG. 3 is similar to the dual-phase DC-DC converter 200 in FIG. 2. Different from the dual-phase DC-DC converter 200 in FIG. 2, the dual-phase DC-DC converter 300 in FIG. 3 further comprises: a resistor 113, wherein the first capacitor 110 is charged and discharged via the resistor 113.

When the system is in operation, the first logical control signal PWM1 and the second logical control signal PWM2 are desired to be controlled with a phase difference of 180 degrees with each other. When the rising edge of the first logical control signal PWM1 comes, the RS latch 107 is set. Then the square wave signal turns to logical high level. As a result, the first capacitor 110 starts to be charged by the current source 108. When the rising edge of the second logical control signal PWM2 comes, the RS latch 107 is reset. Then the square wave signal turns to logical low level. As a result, the first capacitor 110 starts to be discharged by the current sink 109. So if the phase difference between the first logical control signal PWM1 and the second logical control signal PWM2 is 180 degrees, the square wave signal would have a duty cycle of 50%, and the compensation voltage V_{C} across the first capacitor 110 would have a constant average value; if the phase difference between the first logical control signal PWM1 and the second logical control signal PWM2 is less than 180 degrees, the square wave signal would have a duty cycle lower than 50%, and the average value of the compensation voltage V_{C} across the first capacitor 110 would decrease; and if the phase difference between the first logical control signal PWM1 and the second logical control signal PWM2 is greater than 180 degrees, the square wave signal would have a duty cycle higher than 50%, and the average value of the compensation voltage V_{C} across the first capacitor 110 would increase.

When the average value of the compensation voltage V_{C} increases, the second on time generator 204 generates an increased second on time signal ton2 in response to the increased compensation voltage V_{C}. Accordingly, the switching frequency of the second power switching circuit 203 increases. That is, the switching cycle of the second power switching circuit 203 decreases, which reduces the phase difference between the first logical control signal PWM1 and the second logical control signal PWM2, so as to bring the phase difference to be 180 degrees.

When the average value of the compensation voltage V_{C} decreases, the second on time generator 204 generates a decreased second on time signal ton2 in response to the decreased compensation voltage V_{C}. Accordingly, the switching frequency of the second power switching circuit 203 decreases. That is, the switching cycle of the second power switching circuit 203 increases, which enlarges the phase difference between the first logical control signal PWM1 and the second logical control signal PWM2, so as to bring the phase difference to be 180 degrees.

Several embodiments of the present invention provide a phase detector and phase-locked circuit. The phase detector detects the phases of the first logical control signal PWM1 and the second logical control signal PWM2 through the combination of the RS latch 107, the current source 108, the current sink 109, and the first capacitor 110, and adjusts the switching frequency of the second power switching circuit 203 by adjusting the second on time signal ton2, to maintain the phase difference of the first power switching circuit 103 and the second power switching circuit 203 to be 180 degrees. The phase-locked circuit comprises: the RS latch 107, the first capacitor 110, the current source 108 and the current sink 109.

FIG. 4 schematically shows circuit configurations of the first on time generator 104 and the second on time generator 204 in accordance with an embodiment of the present invention. In the example of FIG. 4, the first on time generator 104 comprises: a middle node 40; a controlled current source 42, configured to provide a controlled current I1 to the middle node 40; a second capacitor 43 and a reset switch 44, coupled in parallel between the middle node and a reference ground; a one shot circuit 45, configured to receive the second logical control signal PWM2, to generate a reset short pulse signal to a control terminal of the reset switch 44 in response to the rising edge of the second logical control signal PWM2; a controlled voltage signal generator 46, configured to generate a controlled voltage signal V_{CON}; and a charge comparator 47, having a first input terminal, a second input terminal and an output terminal, wherein the first input terminal is configured to receive the controlled voltage signal V_{CON}, the second input terminal is coupled to the middle node 40 to receive a voltage across the second capacitor 43, and wherein the charge comparator 47 generates the first on time signal ton1 at the output terminal based on the controlled voltage signal V_{CON} and the voltage across the second capacitor 43. The second on time generator 204 comprises the first on time generator 104, and further comprises: a push pull circuit 41, configured to receive the compensation voltage V_{C} across the first capacitor 110, to generate a compensation current I_{C} at the middle node 40. The second on time signal ton2 is also generated at the output terminal of the charge comparator 47 (as shown in FIG. 4).

In one embodiment, the first power switching circuit 103 and the second power switching circuit 203 adopt same circuit topology. If both the first power switching circuit 103 and the second power switching circuit 203 adopt buck topology, the first on time signal ton1 and the second on time signal ton2 are proportional to the output voltage V_{O} and inversely proportional to the input voltage Vin. If both the first power switching circuit 103 and the second power switching circuit 203 adopt boost topology, the first on time signal ton1 and the second on time signal ton2 are proportional to the difference between the output voltage V_{O} and input voltage Vin, and inversely proportional to the output voltage V_{O}.

In one embodiment, if both the first power switching circuit 103 and the second power switching circuit 203 adopt buck topology, the controlled current I1 is proportional to the input voltage Vin, and the controlled voltage signal V_{CON} is proportional to the output voltage V_{O}. If both the first power switching circuit 103 and the second power switching circuit 203 adopt boost topology, the controlled current I1 is proportional to the output voltage V_{O}, and the controlled voltage signal V_{CON} is proportional to the difference between the output voltage V_{O} and input voltage Vin.

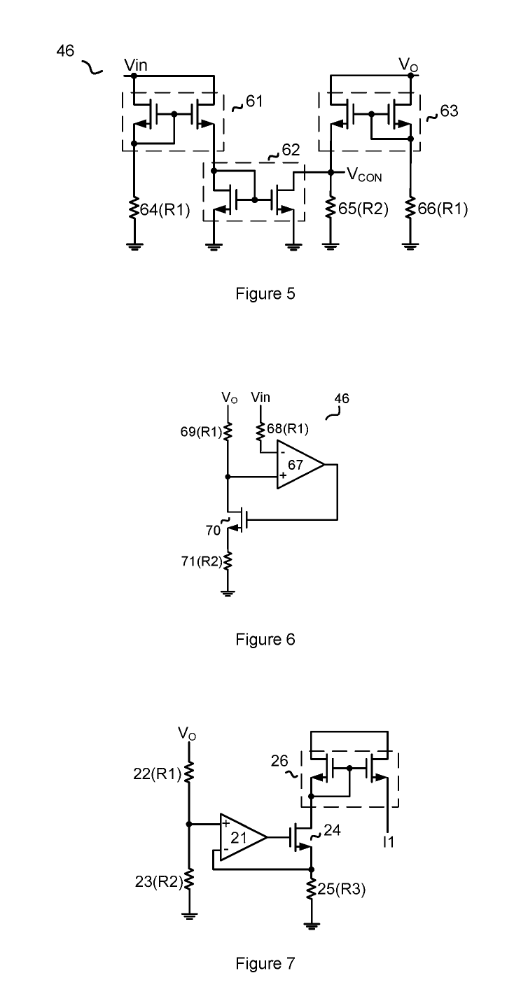

FIG. 5 schematically shows a circuit configuration of the controlled voltage signal generator 46 in accordance with an embodiment of the present invention. In the example of FIG. 5, the controlled voltage signal generator 46 comprises: a first pull-up current mirror 61, having an input terminal, a first current terminal and a second current terminal, wherein the input terminal is configured to receive the input voltage Vin, and the first current terminal is coupled to a resistor 64 with resistance of R1; a pull-down current mirror 62, having a current-in end and a current-out end, wherein the current-in end is coupled to the second current terminal of the first pull-up current mirror 61; and a second pull-up current mirror 63, having an input terminal, a first current terminal and a second current terminal, wherein the input terminal is configured to receive the output voltage V_{O}, the first current terminal is coupled to the current-out end of the pull-down current mirror 62 and to a resistor 65 with resistance of R2, and the second current terminal is coupled to a resistor 66 with resistance of R1; wherein a voltage across the resistor 65 is the controlled voltage signal V_{CON}. So the controlled voltage signal V_{CON} in FIG. 5 has a relationship with the input voltage Vin and the output voltage V_{O} as follow:

$${V}_{CON} = \frac{( {V}_{O} - Vin ) \times R 2}{R 1}$$

FIG. 6 schematically shows a circuit configuration of the controlled voltage signal generator 46 in accordance with an embodiment of the present invention. In the example of FIG. 6, the controlled voltage signal generator 46 comprises: an operational amplifier 67, having a first input terminal, a second input terminal and an output terminal, wherein the first input terminal is configured to receive the input voltage Vin via a resistor 68 with resistance R1, the second input terminal is configured to receive the output voltage V_{O} via a resistor 69 with resistance R1, and the output terminal is coupled to the second input terminal via a transistor 79, and coupled to the reference ground via a resistor 71 with resistance R2. So the controlled voltage signal V_{CON} in FIG. 6 also has a relationship with the input voltage Vin and the output voltage V_{O} as follow:

$${V}_{CON} = \frac{( {V}_{O} - Vin ) \times R 2}{R 1}$$

So the controlled voltage signal generator 46 in both FIG. 5 and FIG. 6 may be used in applications when the first power switching circuit 103 and the second power switching circuit 203 both adopt boost topology.

FIG. 7 schematically shows a circuit configuration of the controlled current source 42 in accordance with an embodiment of the present invention. In the example of FIG. 7, the controlled current source 42 comprises: an operational amplifier 21, having a first input terminal, a second input terminal and an output terminal, wherein the first input terminal is configured to receive the input voltage Vin via a resistor 22 with resistance R1, and coupled to the reference ground via a resistor 23 with resistance R2, and the second input terminal is coupled to the output terminal via a transistor 24, and coupled to the reference ground via a resistor 25 with resistance R3; and a third pull-up current mirror 26, having a current-in end and a current-out end, wherein the current-in end is coupled to the transistor 24, and the current-out end is configured to provide the controlled current I1. So the controlled current I1 in FIG. 7 has a relationship with the output voltage V_{O} as follow:

$$I 1 = \frac{{V}_{O} \times R 2}{( R 1 + R 2 ) \times R 3}$$

So the controlled current source 42 in FIG. 7 may be used in applications when the first power switching circuit 103 and the second power switching circuit 203 both adopt boost topology.

Although the above embodiment only shows the schematic circuit configurations of the controlled current source 42 and the controlled voltage signal generator 46 when the first power switching circuit 103 and the second power switching circuit 203 both adopt boost topology, a person skilled in the art should realize that, the controlled current source 42 and the controlled voltage signal generator 46 can be easily modified to meet the requirements when the first power switching circuit 103 and the second power switching circuit 203 both adopt buck topology.

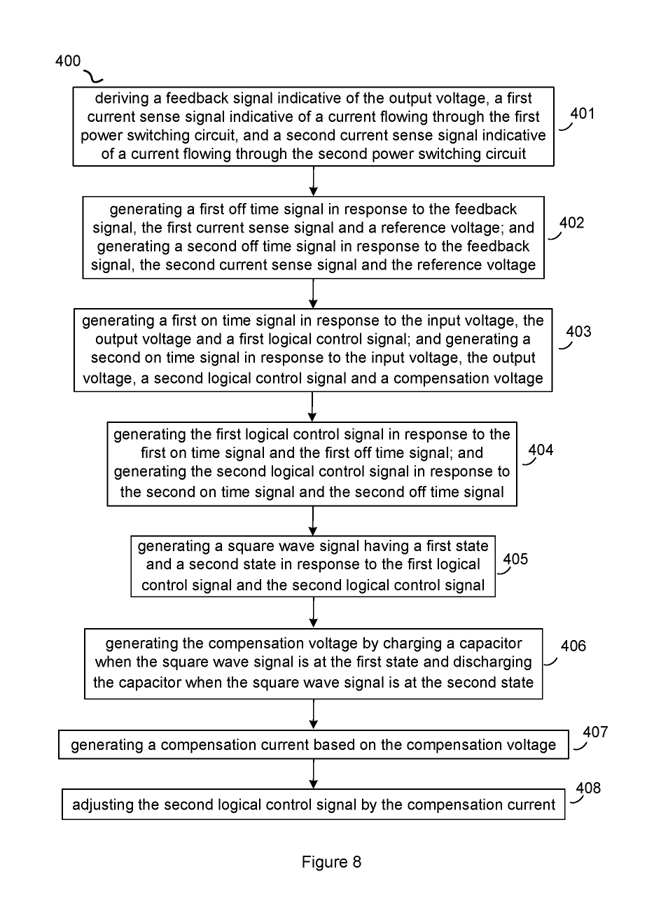

FIG. 8 schematically shows a flow chart 400 of a method used in a dual-phase DC-DC converter, the DC-DC converter including a first power switching circuit and a second power switching circuit coupled in parallel between an input voltage and to an output voltage, the method comprises:

Step 401, deriving a feedback signal indicative of the output voltage, a first current sense signal indicative of a current flowing through the first power switching circuit, and a second current sense signal indicative of a current flowing through the second power switching circuit.

Step 402, generating a first off time signal in response to the feedback signal, the first current sense signal and a reference voltage; and generating a second off time signal in response to the feedback signal, the second current sense signal and the reference voltage. In one embodiment, the first off time signal is generated by following steps: amplifying and integrating a difference between the feedback signal and the reference voltage to generate an error amplified signal; comparing the error amplified signal with the first current sense signal to generate the first off time signal; and comparing the error amplified signal with the second current sense signal to generate the second off time signal.

Step 403, generating a first on time signal in response to the input voltage, the output voltage and a first logical control signal; and generating a second on time signal in response to the input voltage, the output voltage, a second logical control signal and a compensation voltage.

Step 404, generating the first logical control signal in response to the first on time signal and the first off time signal; and generating the second logical control signal in response to the second on time signal and the second off time signal; wherein the first logical control signal and the second logical control signal are used to control the operations of the first power switching circuit and the second power switching circuit, respectively. In one embodiment, the first logical control signal jumps to logical high level in response to a rising edge of the first on time signal, and jumps to logical low level in response to a rising edge of the first off time signal.

Step 405, generating a square wave signal in response to the first logical control signal and the second logical control signal. In one embodiment, the square wave signal jumps to logical high level in response to a rising edge of the first logical control signal, and jump to logical low level in response to a rising edge of the second logical control signal.

Step 406, generating the compensation voltage by charging a capacitor when the square wave signal is at the first state and discharging the capacitor when the square wave signal is at the second state. In one embodiment, the compensation voltage increases linearly when the square wave signal is logical high, and decrease linearly when the square wave signal is logical low.

Step 407, generating a compensation current based on the compensation voltage. In one embodiment, the compensation current is obtained by a push pull circuit.

Step 408, adjusting the second logical control signal by the compensation current.

In one embodiment, the first on time signal is generated by following step: resetting a capacitor for a short pulse time period in response to a rising edge of the first logical control signal; charging the capacitor by a controlled current after the short pulse time period; and comparing a voltage across the capacitor with a controlled voltage signal to generate the first on time signal. And the second on time signal is generated by following steps: resetting a capacitor for a short pulse time period in response to a rising edge of the first logical control signal; charging the capacitor by a controlled current and a compensation current after the short pulse time period; and comparing a voltage across the capacitor with a controlled voltage signal to generate the second on time signal. In one embodiment, the controlled current is proportional to the input voltage and the controlled voltage signal is proportional to the output voltage when the first power switching circuit and the second power switching circuit both adopt buck topology; the controlled current is proportional to the output voltage and the controlled voltage signal is proportional to a difference between the output voltage and the input voltage when the first power switching circuit and the second power switching circuit both adopt boost topology.

Several embodiments of the foregoing dual-phase DC-DC converter effectively control the phase difference between the two power switching circuits. Unlike the conventional technique, several embodiments of the foregoing dual-phase DC-DC converter generate a square wave signal in response to logical control signals which are used to control the power switching circuits. When the square wave signal deviates 50% duty cycle, the on time of the second power switching circuit is adjusted, to ensure the phase difference between the two power switching circuits return to 180 degrees.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

What is claimed is:

1. A dual-phase DC-DC converter with phase lock-up, comprising:
a first power switching circuit and a second power switching circuit coupled in parallel to receive an input voltage and provide an output voltage, the first power switching circuit configured to operate under the control of a first logical control signal, and the second power switching circuit configured to operate under the control of a second logical control signal;
a RS latch, configured to generate a square wave signal in response to the first logical control signal and the second logical control signal, the square wave signal having a first state and a second state; and
a first capacitor, configured to have a compensation voltage across the first capacitor, the first capacitor being charged by a current source when the square wave signal is at the first state and being discharged by a current sink when the square wave signal is at the second state; wherein the second logical control signal is adjusted by the compensation voltage.

2. The dual-phase DC-DC converter of claim 1, further comprising:
a first on time generator, configured to generate a first on time signal in response to the input voltage, the output voltage and the first logical control signal;
a first off time generator, configured to generate a first off time signal in response to a reference voltage, a first current sense signal indicative of a current flowing through the first power switching circuit, and a feedback signal indicative of the output voltage;
a second on time generator, configured to generate a second on time signal in response to the input voltage, the output voltage, the second logical control signal, and the compensation voltage; and
a second off time generator, configured to generate a second off time signal in response to the reference voltage, the feedback signal, and a second current sense signal indicative of a current flowing through the second power switching circuit; wherein
the first logical control signal is generated based on the first on time signal and the first off time signal; and
the second logical control signal is generated based on the second on time signal and the second off time signal.

3. The dual-phase DC-DC converter of claim 2, wherein the second on time generator comprises:
a controlled current source, configured to provide a controlled current;
a push pull circuit, configured to receive the compensation voltage, to generate a compensation current;
a second capacitor and a reset switch, coupled in parallel, wherein the second capacitor is configured to be charged by the controlled current and the compensation current when the reset switch is OFF;
a one shot circuit, configured to receive the second logical control signal, to generate a short pulse signal to turn ON the reset switch in response to a rising edge of the second logical control signal;
a controlled voltage signal generator, configured to generate a controlled voltage signal; and
a comparator, configured to generate the first on time signal by comparing the controlled voltage signal with a voltage across the second capacitor.

4. The dual-phase DC-DC converter of claim 2, wherein
if both the first power switching circuit and the second power switching circuit adopt buck topology, the first on time signal and the second on time signal are proportional to the output voltage, and inversely proportional to the input voltage; and
If both the first power switching circuit and the second power switching circuit adopt boost topology, the first on time signal and the second on time signal are proportional to the difference between the output voltage and input voltage, and inversely proportional to the output voltage.

5. The dual-phase DC-DC converter of claim 1, wherein the current source and the current sink have a same current level.

6. The dual-phase DC-DC converter of claim 1, further comprising:
a first short pulse circuit, configured to generate a first short pulse signal in response to a rising edge of the first logical control signal; and
a second short pulse circuit, configured to generate a second short pulse signal in response to a rising edge of the second logical control signal; wherein
the square wave signal is generated based on the first short pulse signal and the second short pulse signal.

7. A phase locked circuit, used to adjust a phase difference between a first power switching circuit and a second power switching circuit in a dual-phase DC-DC converter, the first power switching circuit being controlled by a first logical control signal, and the second power switching circuit being controlled by a second logical control signal, the phase locked circuit comprising:
a RS latch, configured to generate a square wave signal with a first state in response to the first logical control signal, and generate the square wave signal with a second state in response to the second logical control signal; and
a first capacitor, configured to have a compensation voltage across the first capacitor, the first capacitor being charged by a current source when the square wave signal is at the first state and being discharged by a current sink when the square wave signal is at the second state; wherein the second logical control signal is adjusted by the compensation voltage.

8. The phase locked circuit of claim 7, further comprising:
a first short pulse circuit, configured to generate a first short pulse signal in response to a rising edge of the first logical control signal, so as to trigger the RS latch to generate the square wave signal with the first state; and
a second short pulse circuit, configured to generate a second short pulse signal in response to a rising edge of the second logical control signal, so as to trigger the RS latch to generate the square wave signal with the second state.

9. The phase locked circuit of claim 7, further comprising:
a resistor, wherein the first capacitor is charged and discharged via the resistor.

10. The phase locked circuit of claim 7, further comprising:
a push-pull circuit, configured to receive the compensation voltage to generate a compensation current, wherein the second logical control signal is adjusted by the compensation current.

11. The phase locked circuit of claim 7, wherein the current source and the current sink have a same current level.

12. A method used in a dual-phase DC-DC converter, the dual-phase DC-DC converter including a first power switching circuit and a second power switching circuit coupled in parallel between an input voltage and to an output voltage, the method comprising:
generating a square wave signal having a first state and a second state in response to a first logical control signal and a second logical control signal;
generating a compensation voltage by charging a capacitor when the square wave signal is at the first state and discharging the capacitor when the square wave signal is at the second state; and
adjusting the second logical control signal by the compensation voltage; wherein the first logical control signal and the second logical control signal are used to control the operations of the first power switching circuit and the second power switching circuit, respectively.

13. The method of claim 12, further comprising:
generating a compensation current in response to the compensation voltage; wherein the second logical control signal is adjusted by the compensation current.

14. The method of claim 13, further comprising:
deriving a feedback signal indicative of the output voltage, a first current sense signal indicative of a current flowing through the first power switching circuit, and a second current sense signal indicative of a current flowing through the second power switching circuit;
generating a first off time signal in response to the feedback signal, the first current sense signal and a reference voltage; and generating a second off time signal in response to the feedback signal, the second current sense signal and the reference voltage;
generating a first on time signal in response to the input voltage, the output voltage and the first logical control signal; and generating a second on time signal in response to the input voltage, the output voltage, the second logical control signal and the compensation voltage; and
generating the first logical control signal in response to the first on time signal and the first off time signal; and generating the second logical control signal in response to the second on time signal and the second off time signal.

15. The method of claim 14, wherein the first off time signal is generated by following steps:
amplifying and integrating a difference between the feedback signal and the reference voltage to generate an error amplified signal;
comparing the error amplified signal with the first current sense signal to generate the first off time signal; and
comparing the error amplified signal with the second current sense signal to generate the second off time signal.

16. The method of claim 14, wherein the first on time signal is generated by following steps:
resetting a capacitor for a short pulse time period in response to a rising edge of the first logical control signal;
charging the capacitor by a controlled current after the short pulse time period; and
comparing a voltage across the capacitor with a controlled voltage signal to generate the first on time signal.

17. The method of claim 14, wherein the second on time signal is generated by following steps:
resetting a capacitor for a short pulse time period in response to a rising edge of the first logical control signal;
charging the capacitor by a controlled current and the compensation current after the short pulse time period; and
comparing a voltage across the capacitor with a controlled voltage signal to generate the second on time signal.

18. The method of claim 12, wherein the square wave signal jumps to logical high level in response to a rising edge of the first logical control signal, and jump to logical low level in response to a rising edge of the second logical control signal.
